(19) United States
(12) Patent Application Publication
(10) Pub. No.: US 2025/0333636 A1
(43) Pub. Date: Oct. 30, 2025

(54) FORMULATIONS AND METHODS FOR INHIBITING ENVIRONMENTAL CRACKING

(71) Applicant: Baker Hughes Oilfield Operations LLC, Houston, TX (US)

(72) Inventors: Tracey Jackson, Richmond, TX (US); Shujun Gao, Katy, TX (US); Ronn McKelvey, Bakersfield, CA (US)

(73) Assignee: Baker Hughes Oilfield Operations LLC, Houston, TX (US)

(21) Appl. No.: 18/649,632

(22) Filed: Apr. 29, 2024

(51) Int. Cl. C09K 8/54; E21B 41/02

(52) U.S. Cl. CPC C09K 8/54; E21B 41/02; C09K 2208/32

(57) ABSTRACT

An environmental cracking inhibitor includes a base corrosion inhibitor and a sulfur compound modifier. The base corrosion inhibitor can be an imidazoline, an amine, a quaternary amine, a fatty acid derivative, a phosphate ester, or combinations thereof. The sulfur compound modifier can have the general formula HS—X, where X is a heteroatom substituted alkyl, cycloalkyl, aryl, and/or alkylaryl group. Suitable heteroatoms are sulfur, oxygen, phosphorus, nitrogen, and combinations thereof. The sulfur compound modifier can be 2 mercaptoethanol, cysteamine, or a cysteamine salt.

### FIELD OF THE INVENTION

This invention generally relates to the mitigation of environmental cracking and, more particularly, but not by way of limitation, to a formulation and method for inhibiting sulfide stress cracking in reciprocating pump systems.

### BACKGROUND OF THE INVENTION

Hydrocarbons are often produced from well bores by reciprocating downhole pumps that are driven from the surface by pumping units. Conventionally, the surface pumping unit is connected to its downhole pump by a long string of interconnected rods called sucker rods. Oil and gas operators in recent years have gradually been switching from conventional segmented rods to continuous rods, which make use of an uninterrupted string with a single connection at each of its top and bottom ends. The continuous rod is used to transfer the reciprocating movement from the surface pumping unit to the downhole reciprocating pump to lift oil and gas out of the well.

Continuous rods offer several advantages over conventional segmented rods. In particular, the continuous rods can be deployed from a coiled state in which the continuous rod is wrapped around a transport reel. This expedites the installation of the continuous rod in the well and reduces the number of connection points for the rod string. Continuous rods are also often lighter in weight and less expensive than segmented sucker rods.

Despite these advantages, continuous rods are more vulnerable than conventional segmented rods to unexpected and sudden failure from environmental cracking. Environmental cracking refers to the development of cracks and fissures in a metal that is exposed to stress in a corrosive environment. Although metal components frequently experience environmental cracking, the phenomenon is more common in continuous rods that rely on specialized metal alloys. For example, high-strength alloys and steels often experience brittleness and fracture in the presence of hydrogen sulfide due to sulfide stress cracking. When continuous rods are subjected to tensile stress in even a mildly corrosive environment, environmental cracking can rapidly progress and weaken the rods, often through microscopic cracking that is difficult to detect. For this reason, structural failures due to environmental cracking are difficult to predict.

Conventional corrosion inhibitors have proven ineffective at slowing the failure rates of continuous rod applications due to environmental cracking. Indeed, environmental cracking is different from ordinary ferrous metal corrosion, and environmental cracking can occur in the absence of corrosion based solely on factors such as stress and fatigue. Typical corrosion inhibitors therefore provide no apparent resistance to rod failures induced by environmental cracking. A need exists, therefore, for effective chemical intervention to address environmental cracking in continuous rod applications. The present disclosure is directed at these and other deficiencies in the prior art.

### SUMMARY OF THE INVENTION

In one aspect, the present disclosure is directed to an environmental cracking inhibitor that includes a first base corrosion inhibitor, a second base corrosion inhibitor, and a sulfur compound modifier. The sulfur compound modifier can be a thiol such as 2 mercaptoethanol, cysteamine, or a cysteamine salt. The first and the second base corrosion inhibitors can independently be an imidazoline, an amine, a quaternary amine, a fatty acid derivative, or a phosphate ester.

In other aspects, the present disclosure is directed to an environmental cracking inhibitor that includes a base corrosion inhibitor and a sulfur compound modifier having the general formula HS-X, wherein X is a group comprising at least one heteroatom selected from sulfur, oxygen, phosphorus, and nitrogen. The environmental cracking inhibitor optionally includes a solvent, a surfactant, and a demulsifier.

In yet other aspects, the present disclosure provides methods of inhibiting environmental cracking in a continuous rod installed in a well. The methods include the steps of combining a base corrosion inhibitor with a sulfur compound modifier to prepare an environmental cracking inhibitor, and placing the environmental cracking inhibitor into the well to place the environmental cracking inhibitor into contact with the continuous rod.

### BRIEF DESCRIPTION OF DRAWINGS

The above and other objects and advantages of this invention may be more clearly seen when viewed in conjunction with the accompanying drawing wherein:

FIG. 1 is a photograph of an experimental setup for performing an environmental cracking test in a H2S-containing corrosive environment.

FIG. 2A is a photograph of the side of a C-ring coupon prior to exposure to the corrosive environment of the environmental cracking test.

FIG. 2B is a close-up photograph of a top edge of the C-ring coupon of FIG. 2A.

FIG. 2C is a close-up photograph of a bottom edge of the C-ring coupon of FIG. 2A.

FIG. 3 depicts a top view of the C-ring coupon illustrating the stress-inducing bolt.

FIGS. 4A is a photograph of the side of the C-ring coupon after exposure to the corrosive environment of the environmental cracking test in which only a conventional (control) corrosion inhibitor was used.

FIG. 4B is a close-up photograph of the top edge of the C-ring coupon of FIG. 4A.

FIG. 4C is a close-up photograph of the top of the C-ring coupon of FIG. 4A.

FIG. 4D is a close-up photograph of the bottom edge of the C-ring coupon of FIG. 4A.

FIG. 5A is a photograph of the side of the C-ring coupon after exposure to the corrosive environment of the environmental cracking test in which a corrosion inhibitor formulated in accordance with exemplary embodiments was used.

FIG. 5B is a close-up photograph of the top edge of the C-ring coupon of FIG. 5A.

FIG. 5C is a close-up photograph of the top of the C-ring coupon of FIG. 5A.

FIG. 5D is a close-up photograph of the bottom edge of the C-ring coupon of FIG. 5A.

### DETAILED DESCRIPTION

It has been discovered that combining a conventional corrosion inhibitor formulation with certain sulfur compounds provides a synergistic formulation that inhibits environmental cracking in the metals and metal alloys used in modern continuous rods. Treatment of continuous rods with the synergistic combination minimizes wear from environmental cracking and allows the continuous rods to achieve their theoretical maximum benefits as described above, while reducing the downtime and costs associated with replacing damaged or failed rods. For example, but without limitation, this synergistic combination inhibits sulfide stress cracking in metals and metal alloys subject to hydrogen sulfide-containing environments.

Based on the foregoing, an environmental cracking inhibitor includes a synergistic combination of a base corrosion inhibitor and a sulfur compound modifier. The base corrosion inhibitor includes one or more conventional corrosion inhibitors (e.g., a first base corrosion inhibitor and a second base corrosion inhibitor, etc.). Suitable conventional corrosion inhibitors include imidazolines, amines, quaternary amines, fatty acid derivatives (e.g., dimers, trimers, and maleated tall oil fatty acids, each derived from tall oil fatty acids), and phosphate esters.

In general, the sulfur compound modifier of the environmental cracking inhibitor is a thiol compound or other sulfur-containing compound. In one embodiment, the sulfur compound modifier is cysteamine, a cysteamine salt, or a combination of cysteamine and cysteamine salts. The cysteamine salt in one embodiment is cysteamine hydrochloride.

In other embodiments, the sulfur compound modifier has the general formula HS-X, where X is a group having at least one heteroatom (i.e., an atom other than carbon and hydrogen) and from 1 to 12 carbon atoms (or any value or range therebetween, including without limitation from 2 to 6 carbon atoms). The at least one heteroatom may be oxygen, sulfur, phosphorous, or nitrogen. Suitable sulfur compounds include without limitation 2 mercaptoethanol, bis (2-mercaptoethyl) sulfide, 2-mercaptoethyl disulfide, 1,8 dimercapto-3,6-dioxaoctane, mercaptoacetic acid, glyceryl monothioglycolate, 2 mercaptophenol, 4-mercaptophenol, 1 ethane-1,2-dithiol, cystine, cysteine, thiolactic acid, 1,3,5-triazine-2,4,6-trithiol, 3-mercaptopropanol, 2-mercaptopropanol, 1-mercapto-2-propanol, 5 amino-2-mercaptobenzimidazole, and salts of any of the foregoing sulfur compounds.

In exemplary embodiments, the stress crack corrosion inhibitor includes from about 1 wt. % to about 20 wt. % sulfur compound modifier (and any range or value therebetween) and from about 2 wt. % to about 20 wt. % base corrosion inhibitor (and any range or value therebetween). In one embodiment, the environmental cracking inhibitor includes about 4 wt. % base corrosion inhibitor and about 2.5 wt. % sulfur compound modifier. In another embodiment, the environmental cracking inhibitor includes about 10 wt. % first base corrosion inhibitor, about 10 wt. % second base corrosion inhibitor, and about 20 wt. % sulfur compound modifier.

In some embodiments, the environmental cracking inhibitor includes a solvent. In one embodiment, suitable solvents for use in the environmental cracking inhibitor include alkylene carbonates, glycols, glycol ethers, aromatic solvents, alcohols, mineral oil, water, and combinations thereof. The solvent in one embodiment is methanol. The solvent content in the environmental cracking inhibitor can range from about 60 wt. % to about 95 wt. % (and any range or value therebetween). In one embodiment, the environmental cracking inhibitor includes about 87 wt. % solvent.

In various embodiments, the environmental cracking inhibitor further includes a surfactant, a demulsifier, or both. In such embodiments, the surfactant content in the environmental cracking inhibitor ranges from about 1 wt. % to about 7 wt. % (and any range or value therebetween). In a particular embodiment, the environmental cracking inhibitor includes about 2 wt. % surfactant. The amount of demulsifier in the environmental cracking inhibitor ranges from about 1 wt. % to about 5 wt. % (and any range or value therebetween). In one particular embodiment, the environmental cracking inhibitor includes about 2.5 wt. % demulsifier.

Thus, in exemplary embodiments, the environmental cracking inhibitor includes a base corrosion inhibitor combined with a sulfur compound modifier, which can be further combined with selected solvents, surfactants, and demulsifiers. A method of making the environmental cracking inhibitor involves the steps of introducing the sulfur compound modifier (e.g., a thiol compound) to the base corrosion inhibitor in selected ratios, and then adding the optional solvents, surfactants, and demulsifiers in selected ratios.

In exemplary embodiments, the environmental cracking inhibitor is beneficially applied to the continuous rod or other treatment target on a one-time, continuous, or periodic basis. The environmental cracking inhibitor can be delivered in a concentrated form. For wellbore applications, the concentrated form can be applied to the impacted region by injection through capillary tubing, chemical injection plunger, or other common chemical treatment delivery mechanisms. For application to surface-based equipment or facilities, the concentrated environmental cracking inhibitor can be applied by pumping, spraying, soaking, or otherwise contacting the equipment/facilities with the environmental cracking inhibitor.

In an embodiment, the step of contacting the continuous rod with the environmental cracking inhibitor includes pumping the environmental cracking inhibitor into a wellbore in which the continuous rod is disposed. Alternatively, the environmental cracking inhibitor can be mixed with a suitable carrier fluid and pumped into the wellbore or through surface-based facilities and equipment. The carrier fluid may be an aqueous or oil-based solution, and suitable non-limiting carrier fluids include water, brine, liquid hydrocarbons (e.g., diesel, crude oil, kerosene), organic solvents (e.g., glycols such as monoethylene glycol, alcohols such as methanol), and combinations of the same. In some embodiments, the environmental cracking inhibitor is mixed into the carrier fluid in a concentration range of between about 1,000 ppm (0.1 wt. %) and about 500,000 ppm (50 wt. %) environmental cracking inhibitor based on the carrier fluid. In yet another embodiment, the continuous rod is contacted with the environmental cracking inhibitor using a brush coating system prior to insertion of the continuous rod into a wellbore. More particularly, in one embodiment, a tubular brush is clamped onto the continuous rod, such that the brush applies the environmental cracking inhibitor to the continuous rod as it is deployed into the wellbore.

The environmental cracking inhibitor is particularly well suited for treating continuous rods installed in sour wellbore environments with detrimental concentrations of hydrogen sulfide, carbon dioxide, or both present. This sour wellbore environment creates an acidic pH condition that is highly corrosive to the continuous rod.

The environmental cracking inhibitors disclosed herein are particularly effective at treating continuous rods made from alloy materials that include one or more of carbon, copper, iron, molybdenum, zinc, vanadium, manganese, chromium, cobalt, tin, nickel, phosphorous, sulfur, silicon, and tungsten. For example, the environmental cracking inhibitor can be beneficially applied to mitigate environmental cracking on continuous rods manufactured from carbon-manganese alloy steel, chromium-molybdenum alloy steel, and nickel-chromium-molybdenum alloy steel. Table 1 depicts the chemical composition for several target metals that are good candidates for treatment with the environmental cracking inhibitors disclosed herein:

TABLE 1
Chemical Composition of Target Metals

| Material | C | Mn | P | S | Si | Ni | Cr | Mo | Cu | Al | Ti | Va |
|---|---|---|---|---|---|---|---|---|---|---|---|---|
| 1536M | 0.31 | 1.10 | 0.015 | 0.010 | 0.15 | 0.25 | 0.25 | 0.050 | 0.35 | 0.020 | — | — |
| | to | to | | | to | max | max | max | max | to | | |
| | 0.35 | 1.30 | | | 0.35 | | | | | 0.050 | | |
| 4120M | 0.18 | 0.40 | 0.015 | 0.010 | 0.15 | 0.25 | 1.80 | 0.15 | 0.20 | 0.005 | 0.005 | — |
| | to | to | | | to | max | to | to | to | to | to | |
| | 0.23 | 0.60 | | | 0.30 | | 2.00 | 0.20 | 0.30 | 0.020 | 0.020 | |
| 4320M | 0.17 | 0.45 | 0.015 | 0.010 | 0.15 | 0.95 | 0.95 | 0.20 | 0.20 | 0.020 | 0.005 | |
| | to | to | | | to | to | to | to | to | to | to | — |
| | 0.22 | 0.65 | | | 0.35 | 1.10 | 1.10 | 0.30 | 0.30 | 0.050 | 0.020 | |
| 4142M | 0.40 | 0.75 | 0.035 | 0.040 | 0.15 | 0.25 | 0.80 | 0.15 | | | | 0.020 |
| | to | to | max | max | to | max | to | to | 0.45 | — | — | to |
| | 0.45 | 1.00 | | | 0.35 | | 1.10 | 0.25 | | | | 0.030 |

Table 2 outlines the mechanical properties for several examples of continuous rod materials that are candidates for treatment with the environmental cracking inhibitors disclosed herein. These continuous rods are categorized as Grade D by the American Petroleum Institute (“API”), but it will be appreciated that continuous rods suitable for treatment with the environmental cracking inhibitor can be found in each of the following API categories: D Grade, DE Grade, DW Grade, ME Grade, SE Grade, and SW Grade.

TABLE 2
Mechanical Properties of Exemplary Continuous Rods.

| | | Tensile Strength | | Yield Strength (min., | | Elong | | |
|---|---|---|---|---|---|---|---|---|
| | | (min.) | | 0.2% offset) | | (min.) | Hardness (max.) | |
| API Grade | Material | Psi | MPa | psi | MPa | % | Rockwell | Brinell |
| D Carbon | 1536M | 115,000 | 790 | 85,000 | 590 | 10 | 28 | 271 |
| D Alloy | 4120M | 115,000 | 790 | 90,000 | 620 | 10 | 28 | 271 |
| D Alloy | 4320M | 115,000 | 790 | 90,000 | 620 | 10 | 30 | 286 |
| D Special | 4120M | 140,000 | 965 | 115,000 | 790 | 4.5 | 36 | 336 |
| D Special | 4320M | 145,000 | 1,000 | 120,000 | 825 | 4.5 | 38 | 353 |

The environmental cracking inhibitor has been found to be effective at treating environmental cracking in continuous rods with relatively high minimum tensile strengths (i.e., ranging from about 115,000 psi to about 145,000 psi) and relatively low chromium content (between about 0.25 wt. % and about 2.0 wt. % chromium).

Although applications of the environmental cracking inhibitor to treat continuous rods have been detailed above, it will be appreciated that the environmental cracking inhibitor may also be used to treat other metal equipment or parts exposed to stress in corrosive or oxidative environments, including but not limited to wellbore tubulars, pipelines, wellheads, production tubing, downhole equipment, process equipment, process tanks and conduits, and storage tanks.

Further, although reference is made to the treatment of sulfide stress cracking using the disclosed environmental cracking inhibitor, it will be appreciated that other forms of environmental cracking. As used herein and unless otherwise limited, the term “environmental cracking” will refer to any metallurgical cracking or other failures caused by environmental sources, including without limitation, caustic cracking, stress corrosion cracking (e.g., as induced by ethanol or ethanol-gasoline blends when transported within steel vessels), hydrogen blistering, hydrogen embrittlement, hydride embrittlement, stepwise cracking, hydrogen stress cracking, and liquid metal cracking.

### Comparative Testing

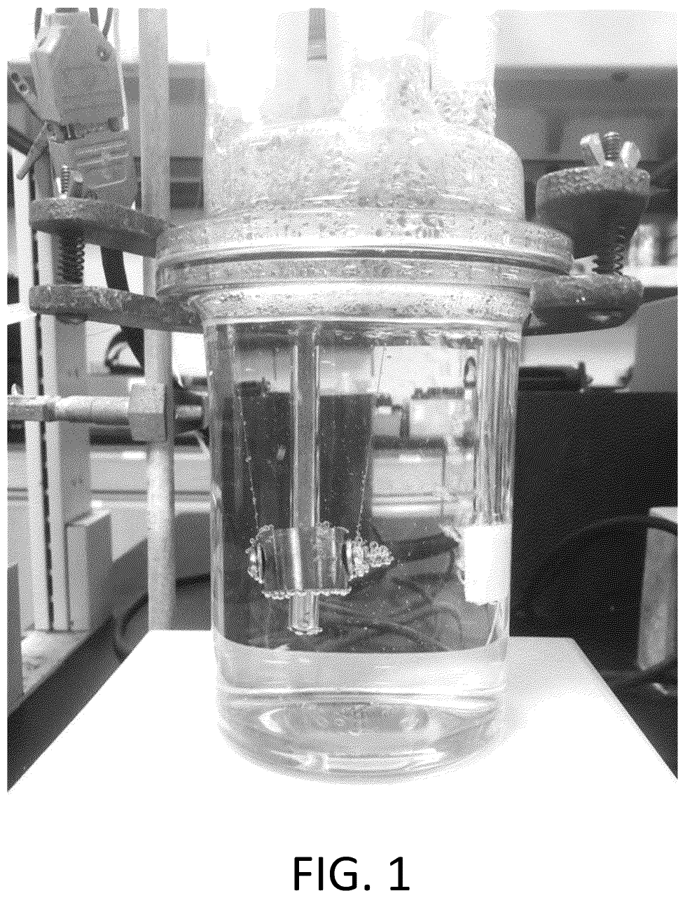

Tests were conducted to compare the effectiveness of the environmental cracking inhibitors disclosed herein against conventional corrosion inhibitors. Generally, the tests included immersing two pre-stressed C-ring coupons of like material and dimensions in corrosive fluids in a kettle cell, as depicted in FIG. 1. A “control” test was carried out using a conventional corrosion inhibitor, while the experimental test was carried out using the novel environmental cracking inhibitor formulated in accordance with embodiments disclosed herein. The tests described below are provided for the purpose of illustration rather than limitation.

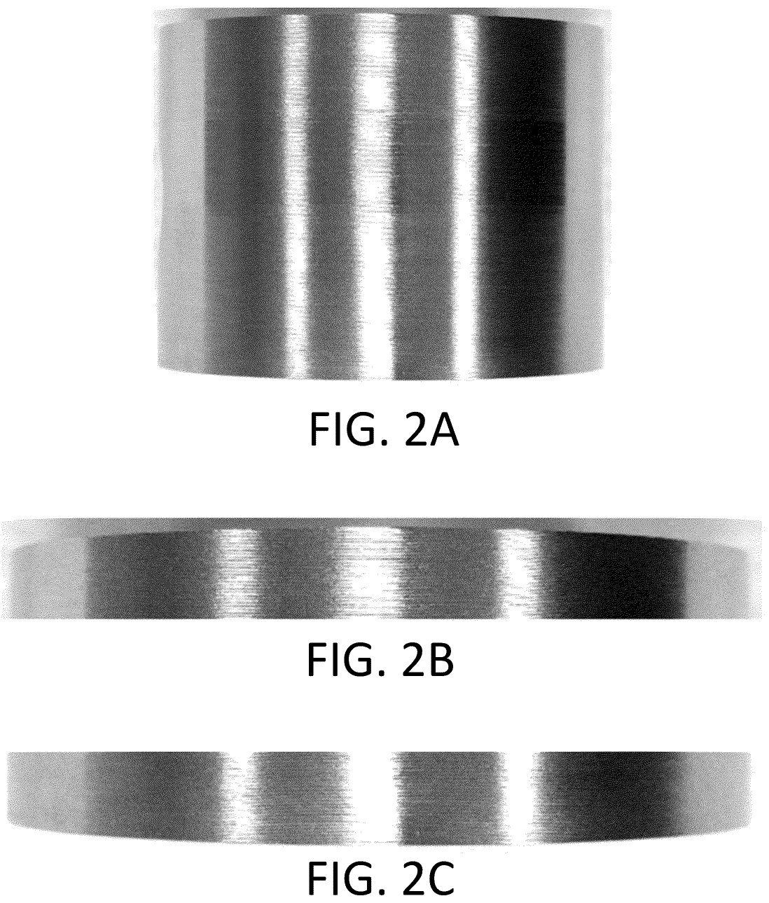

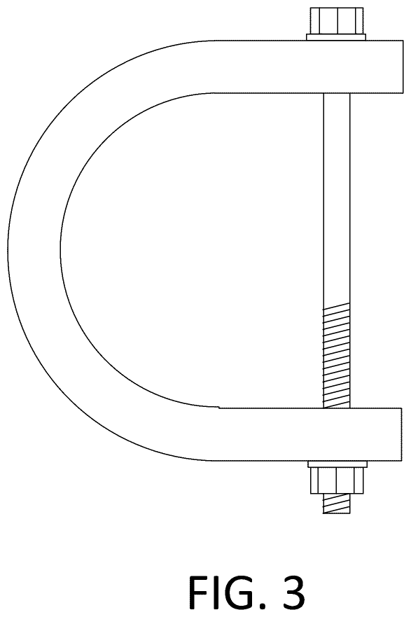

FIGS. 2A-2C present photographs of the side, top edge and bottom edge, respectively, of the C-ring coupons prior to the application of the tensile stresses. As depicted in FIG. 3, the C-ring coupons were stressed by tightening a tension bolt to induce a predetermined tensile stress within the C-ring coupons. The extent of the induced stress was determined by measuring the deflection of the outer diameter (“OD”) of the C-ring coupon with a suitable caliper. Each C-ring coupon was machined to the dimensions of 1-inch outer diameter and 1/16-inch thickness, based on the procedure provided by ASTM International's publication entitled “ASTM G383: Standard Practice for Making and Using C-Ring Stress-Corrosion Test Specimens.”

The applied stress on the C-ring coupon was set at 90% of the yield strength (100,000 psi). The stress was applied by measuring the deflection of the OD using a caliper, as given in the NACE TM0177 sour testing standard, and as seen below in Equation 1:

$$D = \frac{π d ( d - t ) S}{4 tE} \qquad ( Equation 1 )$$

where:
D=deflection of the C-ring coupon across bolt holes;
d=OD of the C-ring coupon;
t=thickness of the C-ring coupon;
S=desired outer fiber stress; and
E=modulus of elasticity.

The selected C-ring coupons were constructed from low alloy carbon steel AISI 4142M (UNS No. G41420 under the Unified Numbering System for Metals and Alloys) for which the composition is given in Table 3.

TABLE 3
Chemical Composition for AISI 4142M (UNS No. G41420).

| Material | C | Mn | P | S | Si | Ni | Cr | Mo | Cu | Va |
|---|---|---|---|---|---|---|---|---|---|---|
| 4142M | 0.40 to | 0.75 to | 0.035 | 0.040 | 0.15 to | 0.25 | 0.80 to | 0.15 to | 0.45 | 0.020 to |
| | 0.45 | 1.00 | max | max | 0.35 | max | 1.10 | 0.25 | | 0.030 |

The tests were conducted in a kettle cell. The common test solution was Solution B recommended in NACE TM0177, which includes 5.0 wt. % sodium chloride, 2.5 wt. % glacial acetic acid, and 0.41 wt. % sodium acetate dissolved in deionized water. Before testing, the solution was sparged with CO2 for at least two (2) hours to remove dissolved oxygen, and CO2 sparging was maintained during the entirety of the test.

For the control test, a conventional corrosion inhibitor (“P1”) was added to the common test solution. The conventional corrosion inhibitor (P1) was formulated with 4.0 wt. % imidazoline, 1.5 wt. % acetic acid, 1.9 wt. % alkyldimethylbenzylammonium chloride (“ADBAC”) quat, 2.5 wt. % demulsifier, 40.1 wt. % water, and 50 wt. % methanol. For the experimental test, a second treatment solution (“P2”) was prepared using an embodiment of the environmental cracking inhibitor that included 2.5 wt. % cysteamine hydrochloride, 4.0 wt. % imidazoline, 1.5 wt. % acetic acid, 1.9 wt. % ADBAC, 2.5 wt. % demulsifier, 37.6 wt. % water, and 50 wt. % methanol. Importantly, the formulation of the environmental cracking inhibitor used as the second treatment solution closely resembled the conventional corrosion inhibitor (P1) so that the beneficial effects of combining the sulfur compound modifier with the base corrosion inhibitor could be more clearly determined.

For the control and experimental tests, the C-ring coupons were immersed in the common test solution after the kettle cell reached 170° F. For the control test, 60 ppm of PI was injected into the cell. For the experimental test, 60 ppm of P2 was injected into the cell.

Then, 150 ppm sodium sulfide (Na2S) was injected into the cell to simulate a H2S corrosion environment. The Na2S was reinjected at the same amount for each day of testing. While the standard test in NACE TM0177 uses H2S purging, it was deemed safer to use daily Na2S injection for these tests. Due to the daily reinjection of Na2S, the solution pH was maintained from 3.4 to 4.0. The solution also appeared to be very clear a few hours after each injection, indicating that Na2S was successfully converted to dissolved H2S gas. After fourteen (14) days, the C-ring coupons were removed and inspected under a Keyence microscope VHX-2000.

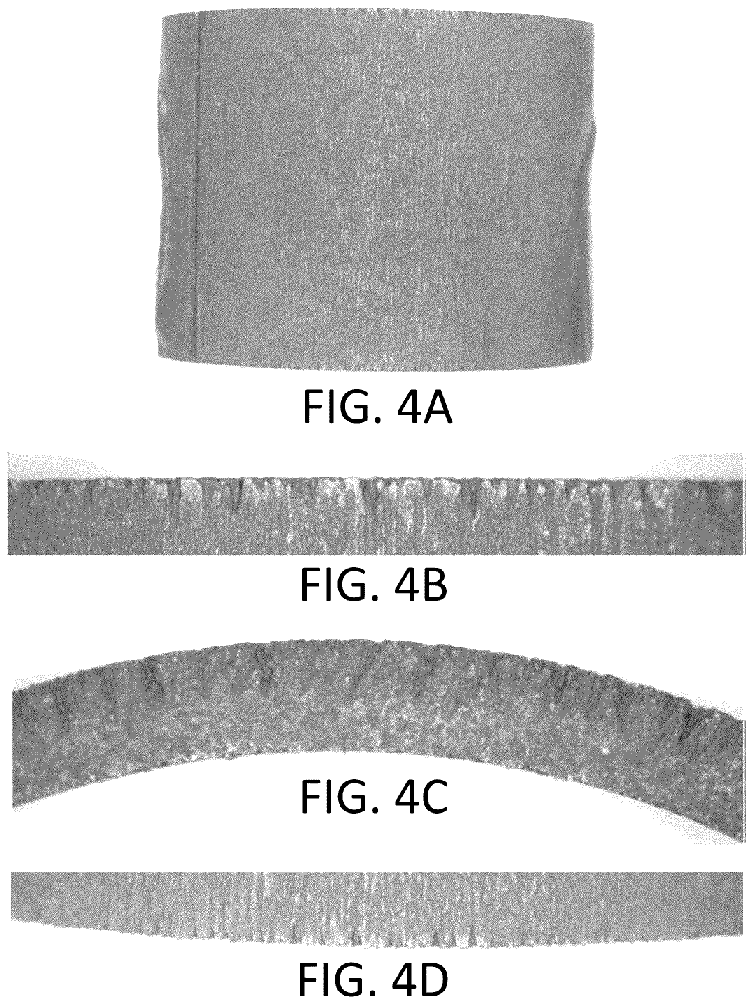

FIGS. 4A through 4D are photographs of the C-ring coupon from the fourteen-day control test. The C-ring coupon from the control test showed aggressive roughening and cracking along the surface of the ring, as well as deep cracks along the top and the side edges of the ring (see FIGS. 4B, 4C, and 4D). This level of environmental cracking could lead to metallurgical failure in a downhole environment. This control illustrates the limitations of the traditional corrosion inhibitor (P1).

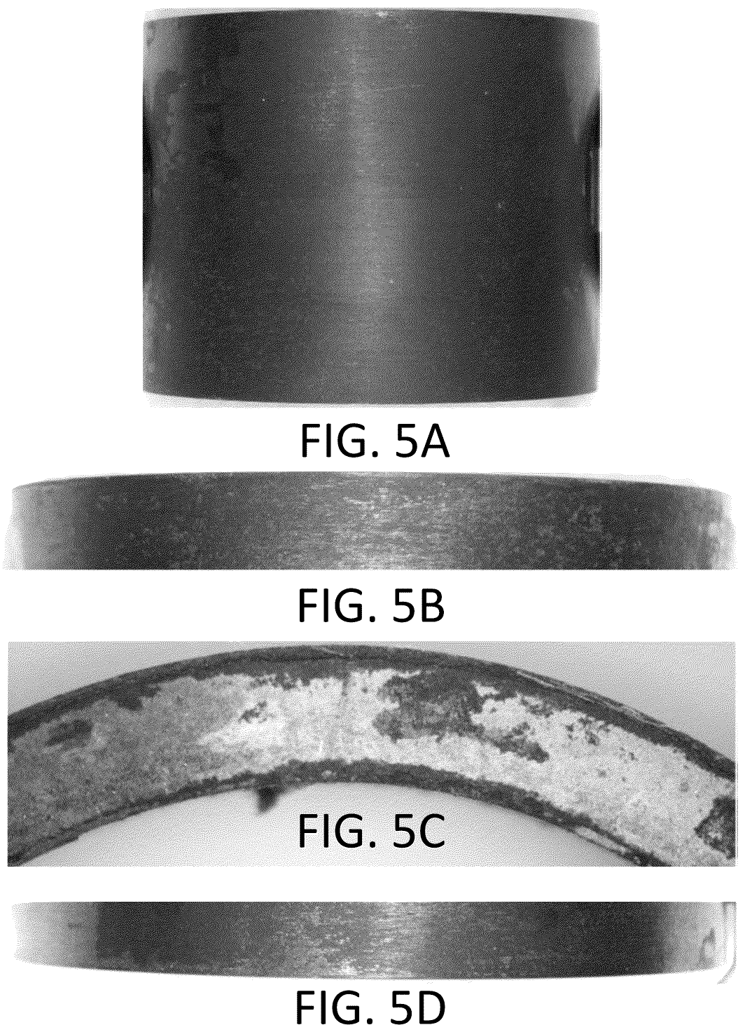

In contrast, FIGS. 5A through 5D provide photographs of the C-ring coupon from the fourteen-day experimental test. The environmental cracking inhibitor (S2) provided a substantial benefit to the C-ring coupon by preventing the same level of environmental cracking seen in the control test. Not only was environmental cracking not present in the experimental test, but the coupon surface was also still very smooth, even retaining some of the machining marks that were seen before exposure. The only visual changes were a slight loss of luster and a blackening of the finish. In summary, the comparative tests indicate that the unmodified conventional corrosion inhibitor product was unable to prevent environmental cracking, while the environmental cracking inhibitor with cysteamine hydrochloride prevented cracking failure.

In the foregoing specification, the invention has been described with reference to specific embodiments thereof. However, it will be evident that various modifications and changes can be made thereto without departing from the broader scope of the invention as set forth in the appended claims. Accordingly, the specification is to be regarded in an illustrative rather than a restrictive sense. For example, sulfur compounds, corrosion inhibitor formulations, corrosion inhibitors, solvents, alloys, sour environments, environmental cracking treatment procedures, proportions, dosages, temperatures, and amounts not specifically identified or described in this disclosure or not evaluated in a particular Example are still expected to be within the scope of this invention.

It will be understood that, as used herein, a range of X wt. % to Y wt. % will be interpreted to include the disclosure of each discrete integer value between X and Y (e.g., X, X+1, X+2 . . . Y−1, Y).

The present invention may suitably comprise, consist of, or consist essentially of the elements disclosed and may be practiced in the absence of an element not disclosed. As used herein, the singular forms “a,” “an,” and “the” are intended to include the plural forms as well, unless the context clearly indicates otherwise. As used herein, the term “about” in reference to a given parameter is inclusive of the stated value and has the meaning dictated by the context (e.g., it includes the degree of error associated with measurement of the given parameter). As used herein, the term “and/or” includes any and all combinations of one or more of the associated listed items.

1. An environmental cracking inhibitor comprising:
a first base corrosion inhibitor;
a second base corrosion inhibitor; and
a sulfur compound modifier.

2. The environmental cracking inhibitor of claim 1, wherein the sulfur compound modifier is a thiol.

3. The environmental cracking inhibitor of claim 2, wherein the thiol compound is 2-mercaptoethanol, cysteamine, or a cysteamine salt.

4. The environmental cracking inhibitor of claim 2, wherein the thiol compound is selected from the group consisting of 2-mercaptoethanol, bis (2-mercaptoethyl) sulfide, 2-mercaptoethyl disulfide, 1,8-dimercapto-3,6-dioxaoctane, mercaptoacetic acid, glyceryl monothioglycolate, 2-mercaptophenol, 4-mercaptophenol, 1-ethane-1,2-dithiol, cystine, cysteine, cysteamine, thiolactic acid, 1,3,5-triazine-2,4,6-trithiol, 3-mercaptopropanol, 2-mercaptopropanol, 1-mercapto-2-propanol, 5-amino-2-mercaptobenzimidazole, and a salt of any of the foregoing sulfur compounds.

5. The environmental cracking inhibitor of claim 1, wherein each of the first and the second base corrosion inhibitors is selected from the group consisting of imidazolines, amines, quaternary amines, fatty acid derivatives, and phosphate esters.

6. The environmental cracking inhibitor of claim 5, wherein the sulfur compound modifier is 2-mercaptoethanol, cysteamine, or a cysteamine salt.

7. The environmental cracking inhibitor of claim 6, wherein the cysteamine salt is cysteamine hydrochloride.

8. An environmental cracking inhibitor, wherein the environmental cracking inhibitor comprises:
a base corrosion inhibitor; and
a sulfur compound modifier having the general formula HS—X, wherein X is a group comprising at least one heteroatom selected from sulfur, oxygen, phosphorus, and nitrogen.

9. The environmental cracking inhibitor of claim 8, wherein the base corrosion inhibitor is selected from the group consisting of imidazolines, amines, quaternary amines, phosphate esters, fatty acid derivatives, and combinations thereof.

10. The environmental cracking inhibitor of claim 9 comprising:
from about 1 wt. % to about 20 wt. % sulfur compound modifier; and
from about 2 wt. % to about 10 wt. % base corrosion inhibitor.

11. The environmental cracking inhibitor of claim 9 comprising:
about 2.5 wt. % sulfur compound modifier; and
about 4 wt. % base corrosion inhibitor.

12. The environmental cracking inhibitor of claim 9, wherein the sulfur compound modifier is selected from the group consisting of 2-mercaptoethanol, bis (2-mercaptoethyl) sulfide, 2-mercaptoethyl disulfide, 1,8-dimercapto-3,6-dioxaoctane, mercaptoacetic acid, glyceryl monothioglycolate, 2-mercaptophenol, 4-mercaptophenol, 1 ethane-1,2-dithiol, cystine, cysteine, cysteamine, thiolactic acid, 1,3,5-triazine-2,4,6-trithiol, 3-mercaptopropanol, 2-mercaptopropanol, 1-mercapto-2-propanol, 5-amino-2-mercaptobenzimidazole, and a salt of any of the foregoing sulfur compounds.

13. The environmental cracking inhibitor of claim 12, wherein the sulfur compound modifier is 2-mercaptoethanol, cysteamine, or a cysteamine salt.

14. The environmental cracking inhibitor of claim 13, wherein the cysteamine salt is cysteamine hydrochloride.

15. The environmental cracking inhibitor of claim 8 further comprising a solvent selected from the group consisting of alkylene carbonates, glycols, glycol ethers, aromatic solvents, alcohols, mineral oil, water, and combinations thereof.

16. The environmental cracking inhibitor of claim 15, wherein the solvent comprises methanol.

17. The environmental cracking inhibitor of claim 15 comprising from about 60 wt. % to about 95 wt. % solvent.

18. The environmental cracking inhibitor of claim 11 further comprising a surfactant and a demulsifier.

19. A method of inhibiting environmental cracking in a continuous rod installed in a well, the method comprising the steps of:
combining a base corrosion inhibitor with a sulfur compound modifier to prepare an environmental cracking inhibitor; and
placing the environmental cracking inhibitor into the well to place the environmental cracking inhibitor into contact with the continuous rod.

20. The method of claim 19, further comprising the step of mixing the environmental cracking inhibitor with a carrier fluid before placing the environmental cracking inhibitor into the well, wherein the environmental cracking inhibitor is combined with the carrier fluid in a ratio of between about 1,000 ppm and about 500,000 ppm environmental cracking inhibitor based on the carrier fluid.
